(19) United States
(12) Patent Application Publication
(10) Pub. No.: US 2023/0346635 A1
(43) Pub. Date: Nov. 2, 2023

(54) Percussive Massage Device and Adaptor

(71) Applicant: Robert Gordon Davis, Carlsbad, CA (US)

(72) Inventor: Robert Gordon Davis, Carlsbad, CA (US)

(21) Appl. No.: 17/733,356

(22) Filed: Apr. 29, 2022

(51) Int. Cl. A61H 23/00

(52) U.S. Cl. CPC A61H 23/006; A61H 2201/165; A61H 2201/1635; A61H 2205/065; A61H 2201/123

(57) ABSTRACT

A percussive massage adaptor and device for delivering effective masseusive contact with a body while providing tactile feedback to the masseuse includes a flexible hand sleeve having a pressure distribution element on a top surface above the masseuse's backhand. A reciprocating shaft, powered by a motor, contacts the pressure distribution element to distribute percussive forces to the hand and fingers of the masseuse.

### FIELD OF THE INVENTION

The present application relates to the massage therapy industry. More particularly, the present invention relates to a wearable hand sleeve that incorporates on-market percussive massage devices to deliver better, healthier physical therapy.

### BACKGROUND OF THE INVENTION

Percussive massage is the application of a rapid pounding force in short duration pulses to an area of the human body. Percussive massage is used to work and strengthen deep-tissue muscles more aggressively than other massage techniques. Percussive massage increases local blood circulation and can even help tone muscle areas. Percussive massage may be applied by a skilled massage therapist using rapid hand movements; however, the manual force applied to the body varies, and the massage therapist may tire before completing a sufficient treatment regime.

Current percussive massage devices include a housing that defines a housing interior, a battery, a motor positioned in the housing and a reciprocating shaft operatively connected to the motor and configured to reciprocate in response to activation of the motor.

Problems in the field include the following. Market massage gun devices (Theraguns® and their various progeny) apply force at only one point at a time. These also fail to allow the person administering massage therapy (self, uncertified or certified therapist) to use their tactile sensitivity and the five points of their fingers and thumb plus their palm (and unobstructed knuckles in the shape of a first) to balance the percussive motions of the singular point of the on-market massage gun.

### SUMMARY OF THE INVENTION

A percussive massage device that comprises a sleeve for receiving a wearer's hand, a pressure distribution element on a top surface of the sleeve, and a slot in the pressure distribution pad that receives a reciprocating shaft of a percussive massage device.

A percussive massage device wherein the reciprocating shaft is connected to a motor and has a tip that engages a contact surface of the flexible pressure distribution element on the sleeve to distribute forces from the reciprocating shaft through a hand inserted in the sleeve.

The percussive massage device may be an adaptor such that there is a housing for mounting a percussive massage device, the percussive massage device comprising a base inserted in the housing, a motor encased in the base, and a reciprocating shaft driven by the motor. The sleeve is connected to the housing and receives a user's hand. The sleeve further has a contact surface for engaging a tip of the reciprocating shaft to distribute forces from the reciprocating shaft through the hand of the user.

### BRIEF DESCRIPTION OF THE DRAWINGS

FIG. 1 is a side view of a percussive massage device including a sleeve showing a percussive massager functionally attached to the sleeve according to an embodiment;

FIG. 2 is a side view of the adaptor of FIG. 1 during the mounting phase of a percussive massager;

FIG. 3 is a detailed view of the slot of the percussive massage device of FIG. 1;

FIG. 4 is a bottom view of the percussive massage device of FIG. 1;

FIG. 5 is a side view of another embodiment of a percussive massage device including an integrated percussive massager;

FIG. 6 is an exploded view of the embodiment of FIG. 5;

FIG. 7 is an isometric view of the embodiment of FIG. 6 showing the sleeve and hand attached, but not the percussive massager;

FIG. 8 is a bottom view of the percussive massage device of FIG. 5.

### DETAILED DESCRIPTION

A percussive massage device and adaptor enables tactile feedback for the user while delivering percussive forces for therapeutic effects. The invention will be described below relative to certain illustrative embodiments, though those skilled in the art will recognize that the invention is not limited to the described embodiments.

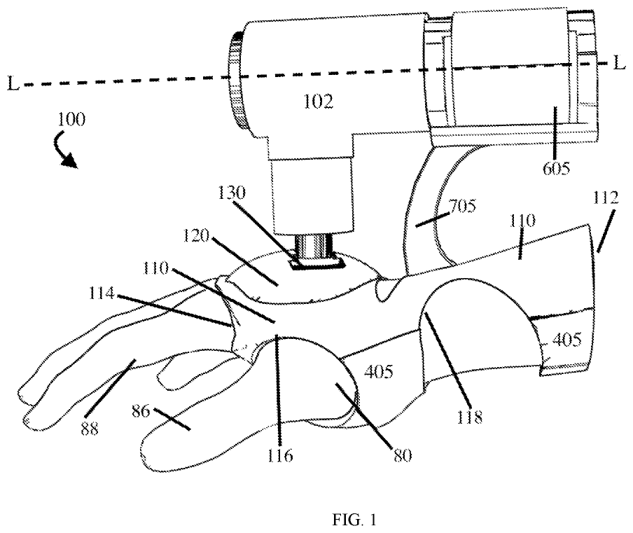

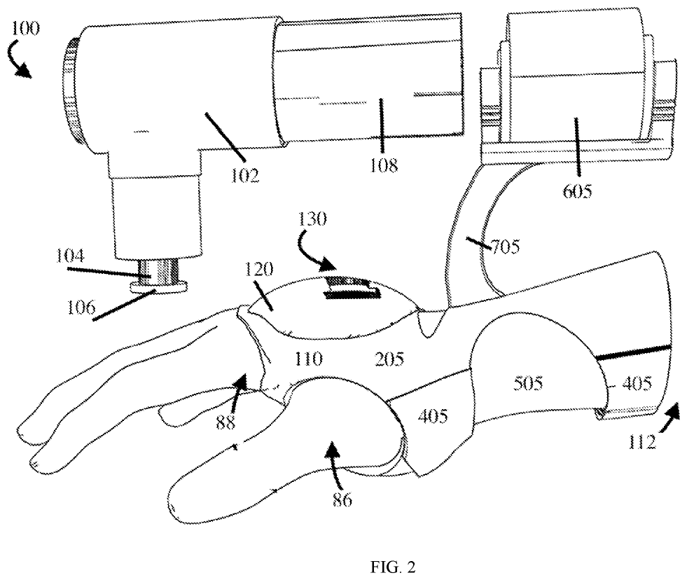

Referring to FIGS. 1-2, a percussive massage device 100 includes an adaptor for mounting a percussive massager 102 to allow a user to deliver effective percussive forces to a body while providing tactile feedback to the user. The illustrative percussive massage adaptor comprises a sleeve 110 for receiving a users' hand 80. The sleeve 110 may comprise a flexible material capable of flexing with the user's movement such as rubber or neoprene. The sleeve includes a first open end 112 through which a user's forearm extends. The sleeve 110 resembles a glovette, having second open end 114 through which the user's fingers 88 extend. The sleeve 110 terminates at the second end so that the user's knuckles are exposed to allow direct masseusive contact with a body by the knuckles when necessary. A thumb opening 116 allows a user's thumb 86 to extend therethrough. A wrist opening 118 facilitates flexing of the sleeve 110 when the user bends his or her wrist. Adjustable straps 405 facilitate insertion, removal, and adjustment of the sleeve 110.

The percussive massage device 100 includes a mount 605 connected to the sleeve 110 via a connecting arm 705. The mount 605 is configured to mount a base 108 of a percussive massager 102. The percussive massager 102 comprises motor encased in a housing extending along a longitudinal axis L-L and a reciprocating shaft 104 extending perpendicular to the housing and driven by the motor, as known in the art. The illustrative reciprocating shaft 104 terminates in a flange 106, but the invention is not so limited. The mount 605 receives and secures the percussive massager in a suitable position and orientation relative to the sleeve through any suitable means known in the art, such as, but not limited to, straps, a snap-fit connection or other suitable attachment mechanisms. The illustrative mount 605 is substantially cylindrical to match the shape of the illustrative massager base 108, but the invention is not so limited.

A pressure distribution element 120 is disposed on a top surface of the sleeve 110 above the backhand of the user. The illustrative pressure distribution element 120 is a substantially dome-shaped pillow, terminating at a distal end that abuts the users' knuckles. The pressure distribution element 120 comprises a material such as Croslite flexible urethane foam or EVA foam, also known as Ethylene-Vinyl Acetate foam. A seat 130 is formed in a top surface of the pressure distribution element 120 for receiving and engaging the reciprocating tip 106 of the percussive massager 102. The illustrative seat 130 selectively locks the reciprocating tip 106 to the pressure distribution element 120 to distribute forces from the reciprocating shaft 104 through a hand inserted in the sleeve 110.

Through the pressure distribution element 120, the reciprocating tip distributes percussive forces to the fingers and knuckles of the users' hand, while allowing tactile feedback to the user regarding the condition of the body, such as particular muscular knots that require masseusive attention.

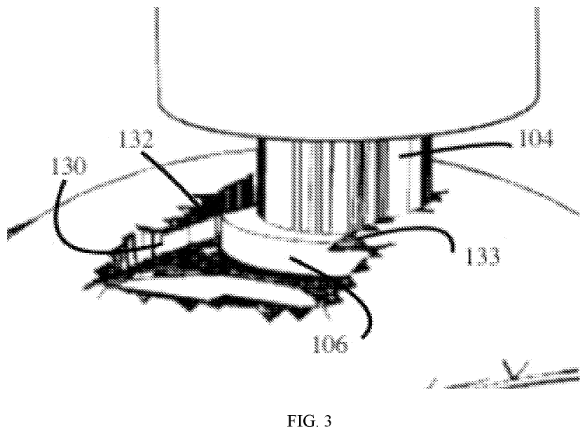

The illustrative seat 130 comprises a slot extending laterally relative to the longitudinal axis L-L of the percussive massager 102, but the invention is not so limited. As shown in FIG. 3, the illustrative slot 130 has an open distal end to allow insertion of the tip 106. The tip 106 slides into engagement in the slot 130, which includes a rounded bottom end and confronting top ledges 132, 133 for containing the tip within the groove. The tip 106 may snap fit into the groove 130, or other latching mechanisms may be used.

In another embodiment, the slot 130 extends parallel or obliquely relative to the longitudinal axis L-L of the percussive massager 102.

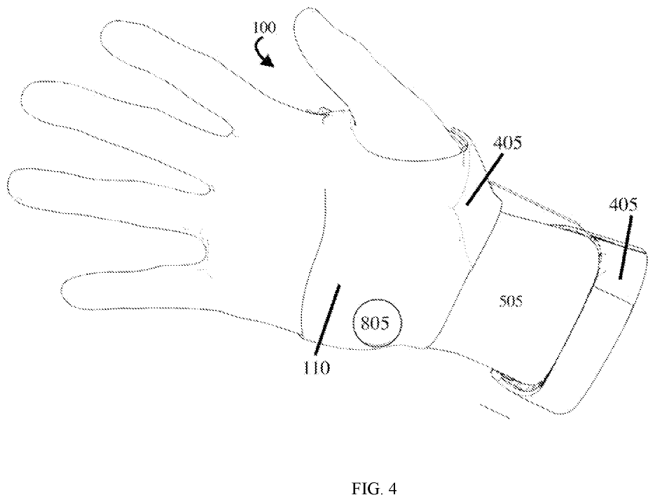

As shown in FIG. 4, the device 100 further includes protrusion 805 extending from a bottom of the sleeve 110 for applying concentrated pressure to a body part. The illustrative protrusion 805 is a hard, dome-shaped element, but the invention is not so limited.

To adapt the percussive massager 102 to the sleeve 110, a user first inserts his hand through the sleeve 110 such that the fingers 88 extend through the front opening 114, the knuckles are exposed, the thumb 86 extends through opening 80 and the pressure distribution element 120 rests above the backhand. The user may adjust the sleeve 110 using the straps 405. Then, the user mounts the percussive massager 102 to the sleeve 110 by inserting the reciprocating tip 106 in the slot 130 and sliding the base 108 into the mount 605. A lock or other securing mechanism secures the base relative to the mount.

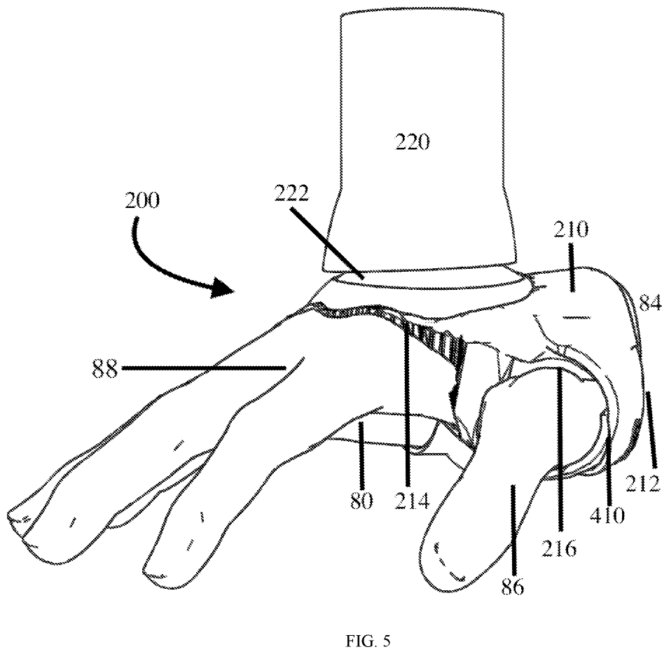

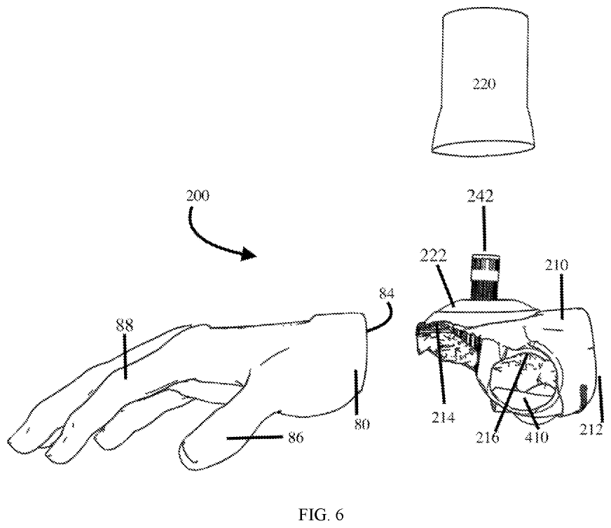

Referring to FIGS. 5-7, in another embodiment, a percussive massage device 200 includes an integral percussive massager 220. The illustrative percussive massage adaptor comprises a sleeve 210 for receiving a user's hand 80. The sleeve 210 may comprise a flexible material capable of flexing with the user's movement such as rubber or neoprene. The sleeve includes a first open end 212 through which a user's forearm 84 extends. The sleeve 210 resembles a glovette, having second open end 214 through which the user's fingers 88 extend. The sleeve 210 terminates at the second end so that the user's knuckles are exposed to allow direct masseusive contact with a body with the knuckles when necessary. A thumb opening 216 allows a user's thumb 86 to extend therethrough. An adjustable strap 410 facilitates insertion, removal, and adjustment of the sleeve 210.

A pressure distribution element 222 is disposed on a top surface of the sleeve above the backhand of the user. The illustrative pressure distribution element 220 is substantially dome-shaped, terminating at a distal end that abuts the users' knuckles. The pressure distribution element 222 comprises a material such as Croslite flexible urethane foam or EVA foam, also known as Ethylene-Vinyl Acetate foam. A reciprocating shaft 242 is formed on and extends vertically from the top surface of the pressure distribution element 222 for receiving and engaging a receiving slot 232 of the percussive massager 220 to integrate the percussive massager 220 with the sleeve 210. The percussive massager 220 sits directly on top of the sleeve 210 via the reciprocating shaft 242 that sits atop the pressure distribution element 222.

The percussive massager 220 includes a motor encased in a housing for driving the reciprocating shaft 242.

Through the pressure distribution element 222, the reciprocating shaft 242 distributes percussive forces to the fingers and knuckles of the users' hand, while allowing tactile feedback to the user regarding the condition of the body, such as particular muscular knots that require masseusive attention.

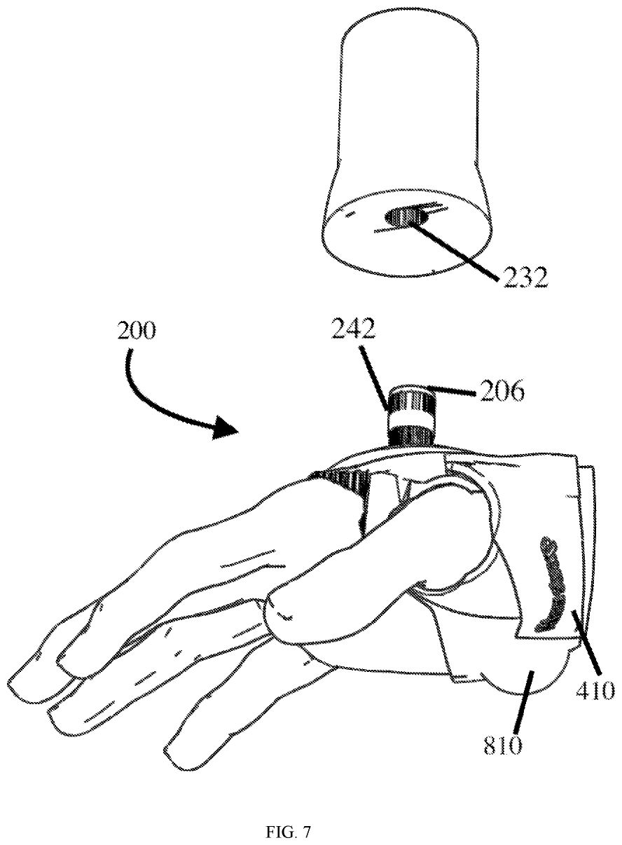

The illustrative receiving slot 232 comprises a slot resembling a circle in the percussive massager 220, but the invention is not so limited and may have any suitable size, shape and orientation suitable for receiving the shaft 242. As shown in FIG. 7, the illustrative slot 232 has an open circular end to allow insertion of the tip 206 of the shaft 242. The tip 206 slides into engagement in the slot 232. The tip 206 may snap fit into the groove 232, or other latching mechanisms may be used.

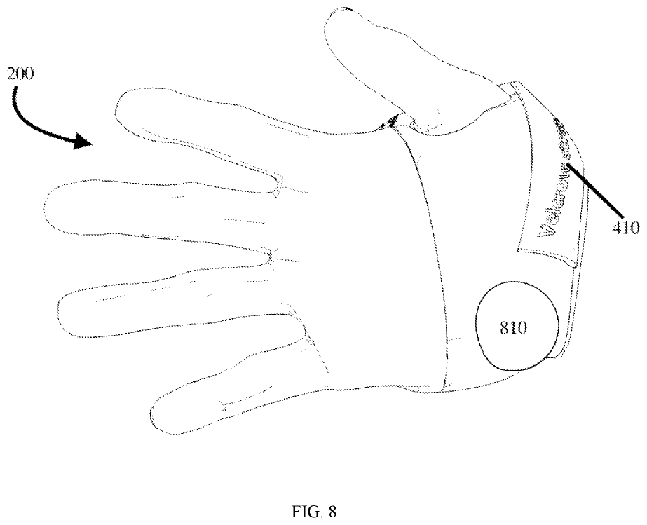

As shown in FIGS. 7 and 8, the device 100 further includes protrusion 810 extending from a bottom of the sleeve 210 for applying concentrated pressure to a body part. The illustrative protrusion 810 is a hard, dome-shaped element, but the invention is not so limited.

To adapt the percussive massager 220 to the sleeve 210, a user first inserts his hand through the sleeve such that the fingers extend through the front opening 214, the knuckles are exposed, the pressure distribution element 222 rests above the backhand. The user may adjust the sleeve 210 using the straps 410. Then, the user mounts the percussive massager 220 to the sleeve 210 by inserting the reciprocating tip 206 in the slot 232. A lock or other securing mechanism secures the base relative to the mount.

The illustrative percussive massage devices facilitates the application of softer, more natural and effective massage movements. In addition, the percussive massage devices may provide percussive massage therapy and relief to the wearer of the sleeves, who may suffer arthritic symptoms like sore fingers and carpal tunnel syndrome.

The invention is not limited to the illustrative embodiments and encompasses variations and alterations of these embodiments.

What is claimed is:

1. A percussive massage device, comprising:
a sleeve for receiving a hand;
a flexible pressure distribution element on a top surface of the sleeve; and
a seat formed on a top surface of the flexible pressure distribution element, the seat configured to receive a tip of a reciprocating shaft to distribute forces from the reciprocating shaft through a hand inserted in the sleeve.

2. The percussive massage device of claim 1, wherein the sleeve resembles a glovette.

3. The percussive massage device of claim 1, wherein the sleeve includes a first opening at a first end for receiving a user's forearm, a second opening at a second end through which a users' fingers extend and a third opening in a side portion near the second end through which a users' thumb extends.

4. The percussive massage device of claim 3, further comprising adjustment straps for adjusting the size of the sleeve.

5. The percussive massage device of claim 4, wherein the sleeve further includes a fourth opening in a bottom side for exposing the users' wrist.

6. The percussive massage device of claim 1, further comprising a housing connected to the sleeve for mounting and positioning a base including a motor for operating the reciprocating shaft.

7. The percussive massage device of claim 6, wherein the housing comprises a cylindrical portion for receiving the base and an arm connecting the housing to the sleeve.

8. The percussive massage device of claim 1, further comprising a protrusion extending from a bottom of the sleeve for applying concentrated pressure to a body part.

9. The percussive massage device of claim 1, wherein the pressure distribution element comprises a substantially dome-shaped pillow formed of a flexible material fixed to the top surface of the sleeve above a users' backhand when a users' hand is inserted in the sleeve.

10. The percussive massage device of claim 1, wherein the seat comprises a groove extending along a top surface of the pressure distribution element.

11. The percussive massage device of claim 10, wherein the groove includes an open end, a closed end and confronting top ledges for containing the tip within the groove.

12. The percussive massage device of claim 10, wherein the groove extends perpendicular to an axis along which the sleeve extends.

13. A percussive massage device, comprising:
a sleeve for receiving a hand;
a flexible pressure distribution element on a top surface of the sleeve; and
a reciprocating shaft connected to a motor, the reciprocating shaft having a tip that engages a contact surface of the flexible pressure distribution element to distribute forces from the reciprocating shaft through a hand inserted in the sleeve.

14. The percussive massage device of claim 13, wherein the contact surface comprises a groove for seating the tip of the reciprocating shaft.

15. The percussive massage device of claim 13, wherein the pressure distribution element comprises a substantially dome-shaped pillow formed of a flexible material fixed to the top surface of the sleeve positioned at the back of a users' hand when a users' hand is inserted in the sleeve.

16. The percussive massage device of claim 13, wherein the motor is housed in a housing connected to the sleeve through an arm extending from the top surface of the sleeve behind the flexible pressure distribution element.

17. A percussive massage device adaptor, comprising:
a housing for mounting a percussive massage device, the percussive massage device comprising a base inserted in the housing, a motor encased in the base and a reciprocating shaft driven by the motor;
a sleeve connected to the housing for receiving a hand of a user; and
a contact surface on the sleeve for engaging a tip of the reciprocating shaft to distribute forces from the reciprocating shaft through the hand of the user.

18. The percussive massage device adaptor of claim 17, wherein the sleeve is connected to the housing via an arm extending from a top surface of the sleeve.

19. The percussive massage device adaptor of claim 17, wherein the contact surface comprises a substantially dome-shaped pillow formed of a flexible material fixed to a top surface of the sleeve.

20. The percussive massage device adaptor of claim 19, wherein the contact surface further comprises a groove formed in the pillow for seating a tip of the reciprocating shaft and which extends parallel to an axis along which the sleeve extends.
